(19) United States
(12) Patent Application Publication
(10) Pub. No.: US 2024/0409010 A1
(43) Pub. Date: Dec. 12, 2024

(54) Lying Position Adjusting Structure of Carrier and Child Safety Seat Using the Same

(71) Applicant: NINGBO WELLDON INFANT AND CHILD SAFETY TECHNOLOGY CO., LTD., Zhejiang (CN)

(72) Inventors: Jiangjuan LlN, Zhejiang (CN); Huanle XIA, Zhejiang (CN)

(73) Assignee: NINGBO WELLDON INFANT AND CHILD SAFETY TECHNOLOGY CO., LTD., Zhejiang (CN)

(21) Appl. No.: 18/810,157

(22) Filed: Aug. 20, 2024

(30) Foreign Application Priority Data
Jan. 5, 2024 (CN) 202420029195.1

(51) Int. Cl. B60N 2/28

(52) U.S. Cl. CPC B60N 2/2821; B60N 2/2842; B60N 2/2878

(57) ABSTRACT

A lying position adjusting structure of a carrier includes a first slider for the upper body of a child to lean against; a second slider used for the lower body of the child to lean against; an adjusting component used for adjusting the included angle between the first slider and the second slider, a housing for providing installation positions; wherein, the first slider, the second slider and the adjusting component are all arranged on the housing.

### CROSS-REFERENCE TO RELATED APPLICATIONS

This application claims the priority of the China Patent Application No. 202420029195.1, filed on Jan. 5, 2024, entitled “Lying Position Adjusting Structure of Carrier and Child Safety Seat Using the Same”, all the contents of and amendments of which are incorporated into this application by reference.

### TECHNICAL FIELD

The present invention relates to the technical field of child safety seats, in particular to a lying position adjusting structure of a carrier and a child safety seat using the same.

### BACKGROUND

Baby carrier, also known as baby lathe, baby car seat or cradle seat, is a small seat specially designed for newborns and babies. The baby carrying carrier is light and easy to carry, which can easily take the baby to outdoor activities, shopping, medical treatment and other places without disturbing the baby's sleep. Moreover, the baby carrier can be fixed on the car seat and used as a car safety seat to ensure the safety of the baby when riding.

The U.S. Pat. No. 20220024359 discloses an “INFANT CARRIER RELEASING STRUCTURE, INFANT CARRIER AND INFANT SAFETY SEAT”. The baby carrier in this patent has an integral structure, and the relative positions of the backrest and leg support parts are fixed, so that the angle between the backrest support surface and the leg support surface of the baby carrier cannot be adjusted, and the baby carrier cannot meet the changing needs of different postures.

Therefore, there is a need to propose a new type of baby carrier, which can adjust the angle between the backrest support surface and the leg support surface of the baby carrier, so as to adapt to the needs of different postures of the baby.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a lying position adjusting structure of a carrier and a child safety seat using the same, so as to solve the problem that the angle between a backrest support surface and a leg support surface cannot be adjusted by the baby carrier in the background technology.

In order to achieve the above object the present invention adopts the following technical solution:
the present invention provides a lying position adjusting structure of a carrier, which includes a first slider used for the upper body of a child to lean against;
a second slider used for the lower body of the child to lean against;
an adjusting component used for adjusting an included angle between the first slider and the second slider; and
a housing for providing installation positions;
wherein the first slider, the second slider and the adjusting component are all arranged on the housing; and
one end of the second slider is hinged with the housing, and the other end of the second slider is hinged with the first slider through a rotating shaft.

The present invention further provides a lying position adjusting structure of a carrier, which includes a first slider and a second slide piece, wherein that first slider and the second slider are respectively used for the upper body and the lower body of a child to lean against; and
wherein the lying position adjusting structure further includes an adjusting component for adjusting an included angle between the first slider and the second slider; and

wherein the lying position adjusting structure further includes a housing for providing installation positions;
wherein, one end of the second slider is rotatably connected with the housing, and the other end of the second slider is rotatably connected with the first slider.

The present invention further provides a child safety seat, which includes a housing, wherein
the housing is provided with a seating area for accommodating a child; and
wherein a first slider and a second slider which can rotate relatively are arranged in the seating area; and
wherein, the first slider and the second slider are respectively used for the upper body and the lower body of the child to lean against; and
the housing is further provided with an adjusting component, and the adjusting component is used for adjusting an included angle between the first slider and the second slider.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a structural schematic diagram of Embodiment 1 of the present invention.

FIG. 2 is a schematic structural view of a guide groove according to Embodiment 1 of the present invention.

FIG. 3 is a structural schematic diagram of Embodiment 1 of the present invention.

FIG. 4 is a schematic structural diagram of Embodiment 2 of the present invention.

FIG. 5 is a sectional view of Embodiment 2 of the present invention.

FIG. 6 is an enlarged view of part A in FIG. 5.

FIG. 7 is a schematic structural view of Embodiment 2 of the present invention with the first slider removed.

FIG. 8 is a sectional view of Embodiment 2 of the present invention with the first slider removed.

FIG. 9 is an enlarged view of part B in FIG. 8.

Reference signs: First slider (1); Second slider (2); Adjusting component (3); Housing (4); Rotating shaft (5); Push-pull element (6); Limit block (7); Limit groove (8); Support block (9); Safety belt (10); Guard plate (11); Fixing point (12); Adjusting button (13); Guide sheet (14); Opening (15); Guide groove (16); Bracket (17); Abutting block (18); Base (19).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,”

“coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

Embodiment 1:

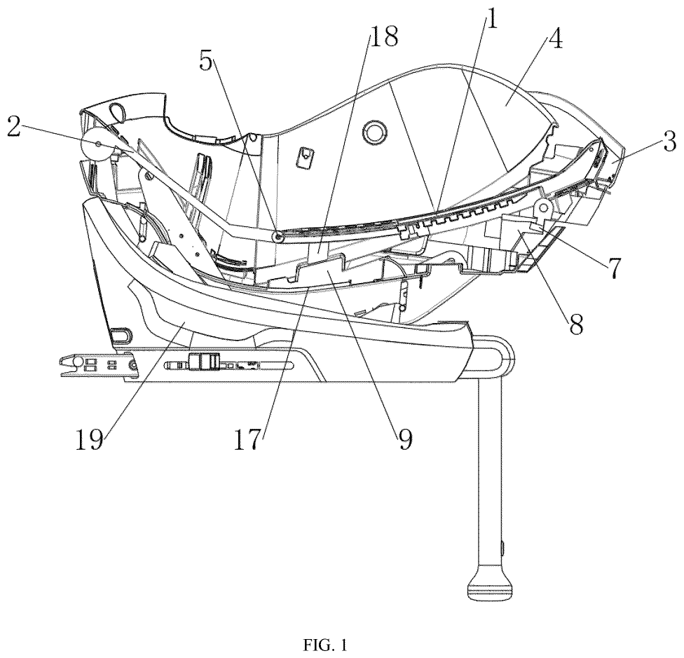

As shown in FIG. 1 to FIG. 3, a lying position adjusting structure of a carrier provided by this embodiment includes:
a first slider 1 used for the upper body of a child to lean against;
a second slider 2 used for the lower body of the child support block;
an adjusting component 3 used for adjusting the included angle between the first slider 1 and the second slider 2;
a housing 4 for providing installation positions.

The first slider 1, the second slider 2 and the adjusting component 3 are all arranged on the housing 4. One end of the second slider 2 is hinged with the housing 4, and the other end of the second slider 2 is hinged with the first slider 1 through the rotating shaft 5. The first slider 1 or the second slider 2 is connected with the adjusting component 3. The included angle between the first slider 1 and the second slider 2 in the initial state is small, and the included angle between the first slider 1 and the second slider 2 is adjusted to increase, so that the first slider 1 and the second slider 2 are flatter to form a lying state of the seat.

The housing 4 can provide installation positions and protect the first slider 1, the second slider 2 and the adjusting component 3. One end of the second slider 2 is hinged with the housing 4, so that one end of the second slider 2 is fixed in position but can still rotate, and at the same time, the other end of the second slider 2 is limited to rotate only around the hinge point of the second slider 2 and the housing 4. The first slider 1 and the second slider 2 are hinged, so that the included angle between the first slider 1 and the second slider 2 can be changed, which is convenient for changing the lying angle. The adjusting component 3 is used to adjust the included angle between the first slider 1 and the second slider 2, which is convenient for controlling the first slider 1 and the second slider 2 to form a normal state and a lying position. The first slider 1 or the second slider 2 is connected with the adjusting component 3, which is convenient for the adjusting component 3 to adjust the angle by controlling the first slider 1 or the second slider 2.

The first slider 1, the second slider 2 and the housing 4 are not limited to articulation mode, but can also be replaced by other rotatable connection methods, such as hinge connection and pin connection.

In this embodiment, the housing 4 is made of a plastic material. The housing 4 can be made of two materials, polypropylene or primary plastic. As a thermoplastic, polypropylene has the characteristics of heat resistance, corrosion resistance and high mechanical strength. Polypropylene is not only environmentally friendly, but also harmless to children's health, creating a safe and healthy riding space for children. It is not easy to break or deform, and has no peculiar smell is released, thus ensuring the comfort and safety of children in the riding process.

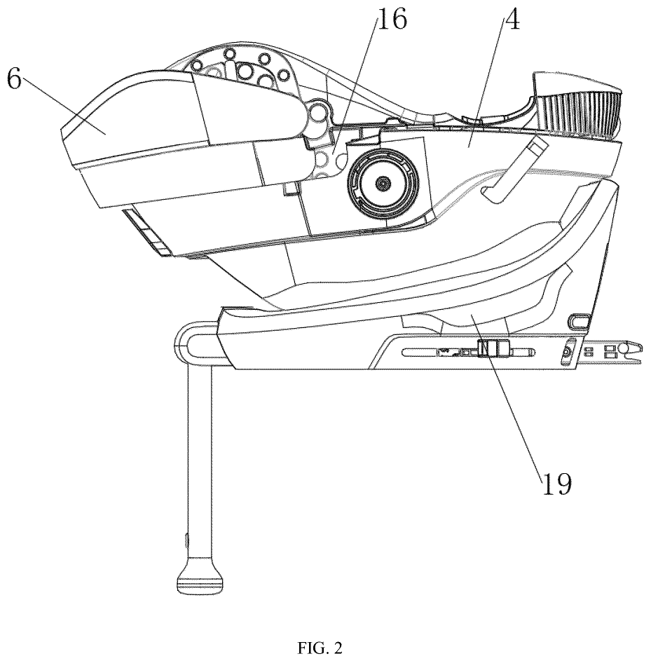

In this embodiment, the adjusting component 3 is connected with the first slider 1. In order to facilitate the adjustment of the normal state and the lying position, as shown in FIG. 2, the adjusting component 3 includes a push-pull element 6, which is connected with the first slider 1 and is movable in a direction away from the first slider 1. The push-pull element 6 is arranged on the housing 4. The design of the push-pull element 6 is convenient for moving the first slider 1 through the push-pull element 6, thereby changing the included angle between the first slider 1 and the second slider 2, and realizing the adjustment of the normal state and the lying position. The push-pull element 6 is arranged on the housing 4 and outside the housing 4, which is convenient for users to use and does not affect the sitting and lying of children inside.

Specifically, the outer surface of the housing 4 is provided with a guide groove 16, and part of the push-pull member 6 is arranged on the guide groove 16, so that the moving direction of the push-pull member 6 is guided by the guide groove 16, and the reliable movement of the push-pull member 6 is ensured. In order to facilitate the adjustment between the normal state and the lying position, it also includes a limit block 7, and the limit block 7 is used to limit the maximum extension range of the first slider 1. The limit block 7 is arranged on the first slider 1, and the housing 4 is provided with a limit groove 8 matched with the limit block 7. The opening of the limit groove 8 faces away from the push-pull element 6, and the limit block 7 is arranged on the limit groove 8. The design of the limit block 7 limits the maximum outward movement distance of the push-pull element 6, which is convenient for controlling the deformation from the normal state to the lying position. The limit groove 8 and the limit block 7 are matched, so that the movement of the first slider 1 is limited by the limit groove 8, and the opening direction of the limit groove 8 is far away from the push-pull element 6, so that the push-pull element 6 pushes outward, so that the limit block 7 moves towards the bottom of the limit groove 8, and finally abuts against the bottom of the limit groove 8 to reach a limited position.

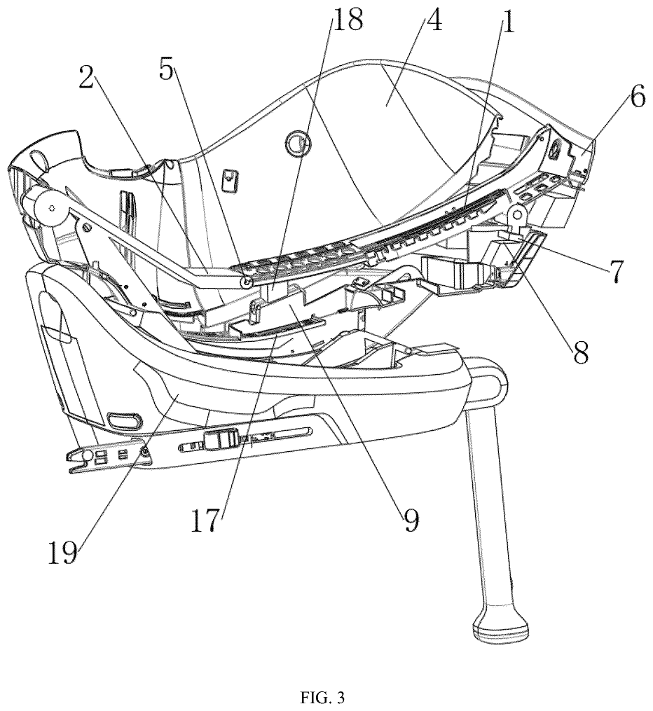

In order to improve the support of lying position, as shown in FIG. 3, the housing 4 is provided with a raised support block 9, which is arranged below the first slider 1 or the second slider 2, and the bottom surface of the first slider 1 or the bottom surface of the second slider 2 abuts against the support block 9 when the first slider 1 and the second slider 2 are unfolded. The design of the support block 9 enables the first slider 1 or the second slider 2 to be supported, ensuring the support reliability in normal state or lying position.

In this embodiment, the support block 9 is arranged below the first slider 1, and the housing 4 includes a bracket 17. The bottom surface of the first slider 1 is provided with a downward protruding abutment block 18, and the support block 9 is arranged on the bracket 17.

When in use, it only needs to pull the push-pull element 6, and the push-pull element 6 will drive the first slider 1 to extend outwards, so that the included angle between the first slider 1 and the second slider 2 is increased, and the normal state of the seat can be adjusted to the lying position.

Embodiment 2:

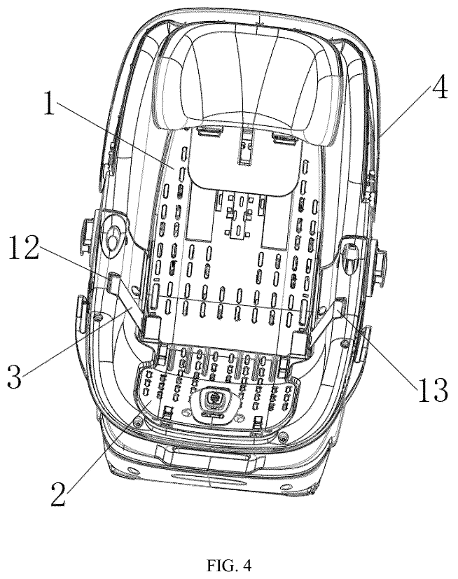

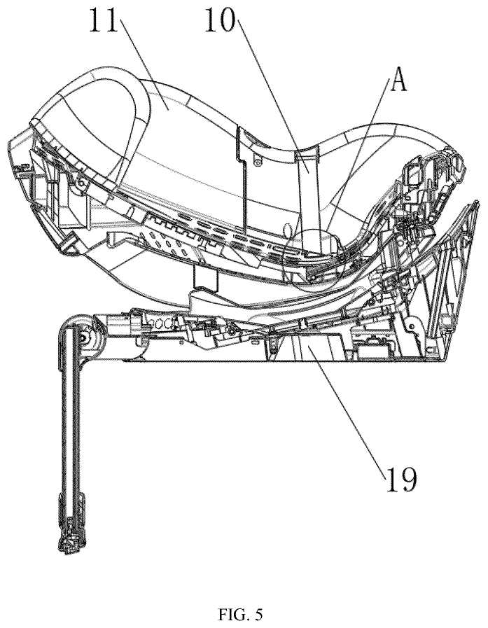

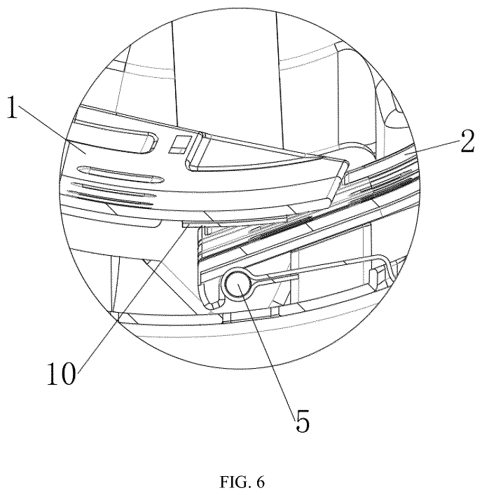

As shown in FIG. 4 to FIG. 6, a lying position adjusting structure of a carrier provided by this embodiment includes:
a first slider 1 used for the upper body of a child to lean against;
a second slider 2 used for the lower body of the child to lean against;
an adjusting component 3 used for adjusting the included angle between the first slider 1 and the second slider 2;
a housing 4 for providing installation positions.

The first slider 1, the second slider 2 and the adjusting component 3 are all arranged on the housing 4. One end of the second slider 2 is hinged with the housing 4, and the other end of the second slider 2 is hinged with the first slider 1 through the rotating shaft 5. Part of the adjusting component 3 is arranged between the first slider 1 and the housing 4 or between the second slider 2 and the housing 4. In order to facilitate the adjustment of normal state and lying position, the adjusting component 3 includes a safety belt 10, and the housing 4 includes two side guard plates 11. One side guard plate 11 is provided with a fixing point 12, and the other side guard plate 11 is provided with an adjusting button 13. One end of the safety belt 10 is connected with the fixing point 12, and part of the safety belt 10 passes under the first slider 1 or the second slider 2 and passes through the adjusting button 13. The design of the guard plate 11 can protect both sides. The design of the safety belt 10 can not only fix children, but also adjust the included angle between the first slider 1 and the second slider 2, and also support under the first slider 1 or the second slider 2. The fixing point 12 is used to fix the safety belt 10 to prevent the safety belt 10 from moving, and the adjusting button 13 is used to control the tightness of the safety belt 10. Part of the safety belt 10 is under the first slider 1 or the second slider 2, which is convenient for pulling up the first slider 1 or the second slider 2 after the safety belt 10 is tightened, so as to adjust the included angle between the first slider 1 and the second slider 2. The adjusting button 13 is a commonly used structure on the safety belt 10, and will not be described in detail in this application.

For more reliable support, a part of the first slider 1 and a part of the second slider 2 overlap, and part of the safety belt 10 is arranged between the first slider 1 and the second slider 2. Part of the first slider 1 and part of the second slider 2 overlap, so that the strength of the main stressed part is strengthened. The safety belt 10 is arranged between the first slider 1 and the second slider 2, so that when the safety belt 10 is pulled up, only the first slider 1 or the second slider 2 is pulled, which can prevent the first slider 1 and the second slider 2 from colliding or crashing. Moreover, the safety belt 10 has a small space in the middle and is not easy to fold.

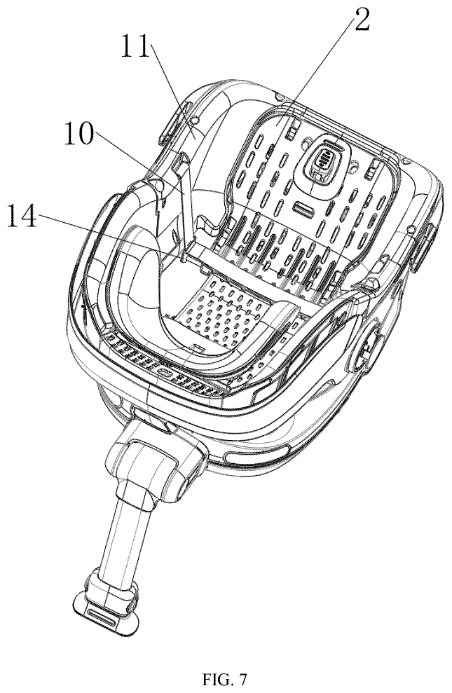

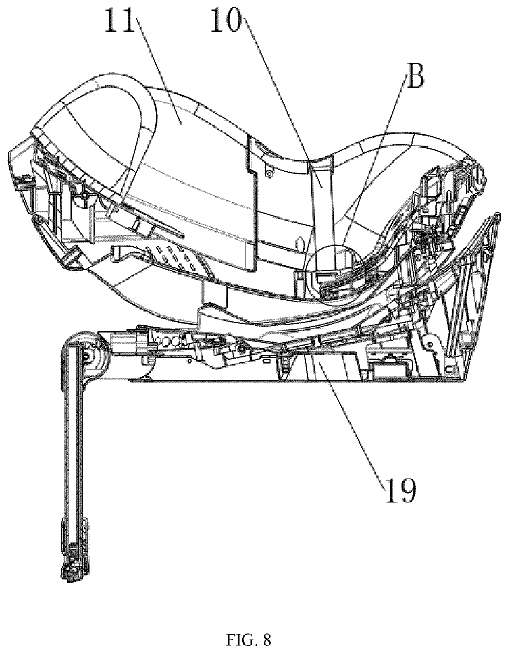

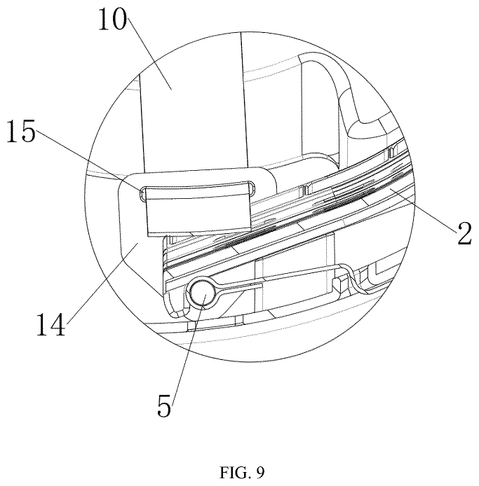

In order to ensure the safety belt 10 to be set reliably, as shown in FIGS. 7 to 9, the adjusting component 3 further includes guide sheets 14, which are arranged on both sides of the first slider 1. The guide sheets 14 are sleeved on the rotating shaft 5, and are provided with openings 15 matched with the safety belt 10, and the openings 15 are arranged above the rotating shaft 5. The design of the guide sheet 14 can make the passing of the safety belt 10 be reliable. The guide sheets 14 are arranged on both sides of the first slider 1, so that the safety belt 10 can be straight between the two guide sheets 14, and the effect of pulling the first slider 1 or the second slider 2 is good. The guide sheet 14 is sleeved on the rotating shaft 5, which can ensure that the guide sheet 14 moves with the rotating shaft 5, so that the safety belt 10 moves with the rotating shaft 5, thus ensuring the arrangement of the safety belt 10.

In order to set the safety belt 10 reliably, the first slider 1 is set above the second slider 2, and part of the upper surface of the safety belt 10 abuts against the bottom surface of the first slider 1. The upper surface of the safety belt 10 abuts against the bottom surface of the first slider 1, so that the safety belt 10 can always be attached to the bottom surface of the first slider 1, and the safety belt 10 can be prevented from being folded.

When in use, the normal state or lying position of the seat can be adjusted only by opening the adjusting button 13 to expand and contract the safety belt 10, so that the included angle between the first slider 1 and the second slider 2 increases or decreases, and the included angle from the normal state to the lying position can be adjusted freely, which is convenient for children to choose a comfortable position. After adjustment, the adjusting button 13 is closed to lock the safety belt 10.

Embodiment 3:

The present invention also provides a child safety seat, which includes a housing 4,
and a seating area for accommodating children is arranged on the housing 4;
wherein a first slider 1 and a second slider 2 which can rotate relatively are arranged in the seating area;
wherein the first slider 1 and the second slider 2 are respectively used for the upper body and the lower body of children to lean against;
the housing 4 is further provided with an adjusting component 3 for adjusting the included angle between the first slider 1 and the second slider 2.

In this embodiment, the preferred connection mode between the first slider 1 and the second slider 2 is that one end of the second slider 1 is hinged with the housing 4, and the other end of the second slider 2 is hinged with the first slider 1 through the rotating shaft 5.

The first slider 1, the second slider 2 and the housing 4 are not limited to articulation mode, but can also be replaced by other rotatable connection methods, such as hinge connection and pin connection.

In this embodiment, the adjusting component 3 includes a push-pull element 6, which is arranged on the housing 4, and the push-pull element 6 is connected with the first slider 1 and is movable away from the first slider 1.

In this embodiment, the housing 4 is provided with a base 19, which is used to be placed on a car seat. The base 19 is the mounting base of the child safety seat in the prior art, and thus will not be described in detail in this application.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for case of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A lying position adjusting structure of a carrier, comprising:
a first slider used for the upper body of a child to lean against;
a second slider used for the lower body of the child to lean against;
an adjusting component used for adjusting an included angle between the first slider and the second slider; and
a housing for providing installation positions;
wherein the first slider, the second slider and the adjusting component are all arranged on the housing; and
one end of the second slider is hinged with the housing, and the other end of the second slider is hinged with the first slider through a rotating shaft.

2. The lying position adjusting structure of a carrier according to claim 1, wherein the adjusting component includes a push-pull element, which is arranged on the housing, is connected with the first slider, and is movable in a direction far away from the first slider.

3. The lying position adjusting structure of a carrier according to claim 2, wherein the adjusting component further includes a limit block, and the limit block is used for limiting a maximum extension range of the first slider.

4. The lying position adjusting structure of a carrier according to claim 3, wherein the limit block is arranged on the first slider, and a limit groove matched with the limit block is arranged on the housing; and an opening of the limit groove faces away from the push-pull element, and the limit block is arranged on the limit groove.

5. The lying position adjusting structure of a carrier according to claim 4, wherein the housing is provided with a raised support block, which is arranged below the first slider or the second slider; and the bottom surface of the first slider or the second slider abuts against the support block when the first slider and the second slider are unfolded.

6. The lying position adjusting structure of a carrier according to claim 1, wherein the adjusting component includes a safety belt, and the housing includes guard plates at two sides, wherein the guard plate at one side is provided with a fixing point, and the guard plate at the other side is provided with an adjusting button.

7. The lying position adjusting structure of a carrier according to claim 6, wherein one end of the safety belt is connected with the fixing point, and part of the safety belt passes under the first slider or the second slider and penetrates through the adjusting button.

8. The lying position adjusting structure of a carrier according to claim 7, wherein part of the first slider and part of the second slider overlap, and part of the safety belt is arranged between the first slider and the second slider.

9. The lying position adjusting structure of a carrier according to claim 8, wherein the adjusting component further includes guide sheets, which are arranged on both sides of the first slider; the guide sheets are sleeved on the rotating shaft, and are provided with openings matched with the safety belt; and the openings are arranged above the rotating shaft.

10. The lying position adjusting structure of a carrier according to claim 9, wherein the first slider is arranged above the second slider, and part of an upper surface of the safety belt abuts against a bottom surface of the first slider.

11. A lying position adjusting structure of a carrier, comprising
a first slider and a second slide piece, wherein that first slider and the second slider are respectively used for the upper body and the lower body of a child to lean against; and
wherein the lying position adjusting structure further includes an adjusting component for adjusting an included angle between the first slider and the second slider; and
wherein the lying position adjusting structure further includes a housing for providing installation positions;
wherein, one end of the second slider is rotatably connected with the housing, and the other end of the second slider is rotatably connected with the first slider.

12. The lying position adjusting structure of a carrier according to claim 11, wherein the first slider, the second slider and the adjusting component are all arranged on the housing.

13. The lying position adjusting structure of a carrier according to claim 12, wherein one end of the second slider is hinged with the housing, and the other end of the second slider is hinged with the first slider through a rotating shaft.

14. A child safety seat comprising a housing, wherein
the housing is provided with a seating area for accommodating a child; and
wherein a first slider and a second slider which can rotate relatively are arranged in the seating area; and
wherein, the first slider and the second slider are respectively used for the upper body and the lower body of the child to lean against; and
the housing is further provided with an adjusting component, and the adjusting component is used for adjusting an included angle between the first slider and the second slider.

15. The child safety seat according to claim 14, wherein one end of the second slider is hinged with the housing, and the other end of the second slider is hinged with the first slider through a rotating shaft.

16. The child safety seat according to claim 14, wherein the adjusting component includes a push-pull element, which is arranged on the housing, is connected with the first slider and is movable in a direction far away from the first slider.

17. The child safety seat according to claim 14, wherein the housing is provided with a base, and the base is used for being placed on an automobile seat.
